(19) United States
(12) Patent Application Publication
(10) Pub. No.: US 2025/0280888 A1
(43) Pub. Date: Sep. 11, 2025

(54) AEROSOL PROVISION DEVICE COMPRISING A MILLIMETER-WAVE BIOMETRIC DETECTOR

(71) Applicant: NICOVENTURES TRADING LIMITED, London (GB)

(72) Inventor: Keith CHURCHES, London (GB)

(21) Appl. No.: 18/858,909

(22) PCT Filed: Apr. 21, 2023
(86) PCT No.: PCT/GB2023/051053

§ 371 Date: Oct. 22, 2024

(30) Foreign Application Priority Data
Apr. 22, 2022 (GB) 2205861.4

(51) Int. Cl. A24F 40/49; A24F 40/50; A24F 40/65; G06F 21/32

(52) U.S. Cl. CPC A24F 40/49; A24F 40/50; A24F 40/65; G06F 21/32

(57) ABSTRACT

There is provided an aerosol provision device, for providing an aerosol for inhalation by a user, comprising: control circuitry for controlling an activation state of the aerosol provision device; a biometric detector arranged to detect a first property associated with a user of the aerosol provision device and provide a signal to the control circuitry, wherein the control circuitry is arranged to update an activation state of the aerosol provision device in response to receiving a signal from the biometric detector associated with a user, wherein the biometric detector comprises a mm wave emitter and receiver.

### TECHNICAL FIELD

The present invention relates to an aerosol provision device, an aerosol provision system, a method of providing an aerosol for inhalation by a user, and aerosol provision means.

### BACKGROUND

Aerosol provision systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### Summary

Aspects of the invention are defined in the accompanying claims.

In accordance with some embodiments described herein, there is provided an aerosol provision device, for providing an aerosol for inhalation by a user, comprising: control circuitry for controlling an activation state of the aerosol provision device; a biometric detector arranged to detect a first property associated with a user of the aerosol provision device and provide a signal to the control circuitry, wherein the control circuitry is arranged to update an activation state of the aerosol provision device in response to receiving a signal from the biometric detector associated with a user, wherein the biometric detector comprises a millimetre (mm) wave emitter and receiver.

Such an arrangement is able to identify a potential user of the aerosol provision device and allow authorised users to operate the device. In particular, the arrangement uses a biometric detector that utilises millimetre emission and detection. Such an arrangement is particular effective in detecting characteristics of one authorised user from the characteristics of an unauthorised user. In particular, the device allows for extremely high definition scanning of e.g. facial features or fingerprints or the like.

The aerosol provision device of the present invention is able to operate in “offline” or “online” mode when identifying potential users. In this way, a valid user may operate the device in offline environment provided the user satisfies the criteria for operation. The user experience of the device is thereby improved.

The arrangement is also able to provide a “plug-and-play” approach. In that, the user may activate the device on first usage and the information from the biometric detector can be used to alter the activation state of the device. In this way, a valid user may have a full range of operational capabilities provided while an invalid user may have only a reduced subset or indeed no operational capabilities provided.

In accordance with some embodiments described herein, there is provided an aerosol provision system for providing an aerosol for inhalation by a user comprising: an aerosol provision device comprising control circuitry for controlling an activation state of the aerosol provision device; and, a biometric detector arranged to detect a first property associated with a user of the aerosol provision device and provide a signal to the control circuitry, wherein the control circuitry is arranged to update an activation state of the aerosol provision device in response to receiving a signal from the biometric detector associated with a user, wherein the biometric detector comprises a mm wave emitter and receiver.

In accordance with some embodiments described herein, there is provided a method of providing an aerosol for inhalation by a user, the method comprising: detecting, by a biometric detector, a first property associated with a user of an aerosol provision device, the detecting comprising emitting and receiving mm wave signals; providing, by the biometric detector, a signal to control circuitry of the aerosol provision device; in response to receiving a signal from the biometric detector, updating, by the control circuitry, an activation state the aerosol provision device.

In accordance with some embodiments described herein, there is provided aerosol provision means, for providing an aerosol for inhalation by a user, comprising: control means for controlling an activation state of the aerosol provision means; biometric detecting means arranged to detect a first property associated with a user of the aerosol provision means and provide a signal to the control means, wherein the control means is arranged to update an activation state of the aerosol provision means in response to receiving a signal from the biometric detecting means associated with a user, wherein the biometric detecting means comprises mm wave emitting and receiving means.

### DESCRIPTION OF DRAWINGS

The present teachings will now be described by way of example only with reference to the following figures:

FIG. 1 is a schematic view of an aerosol provision device according to an example;

FIG. 2 is a schematic view of an aerosol provision system according to an example; and,

FIG. 3 is a flow diagram according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

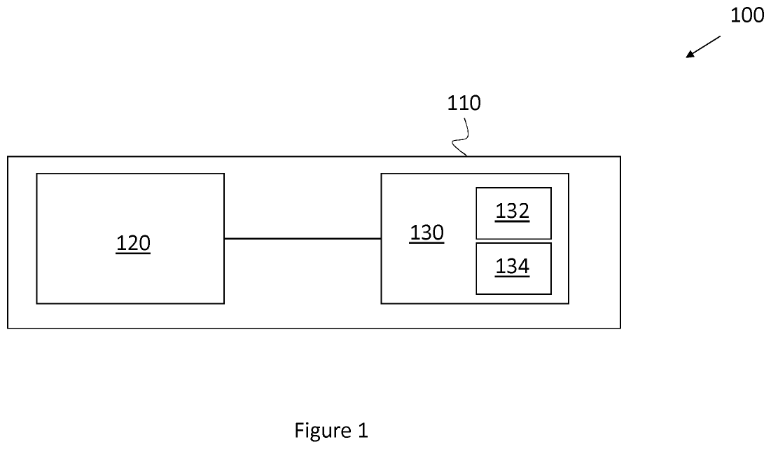

FIG. 1 illustrates a schematic view of an example of an aerosol provision device 100 according to the present invention. The aerosol provision device 100 has an aerosol provision device housing 110. The aerosol provision device 100 has control circuitry 120. The control circuitry 120 is arranged to control an activation state of the aerosol provision device 100. The aerosol provision device 100 comprises a biometric detector 130 arranged to detect a first property associated with a user of the aerosol provision device 100 and provide a signal to the control circuitry 120. The control circuitry 120 is arranged to update an activation state of the aerosol provision device 100 in response to receiving a signal from the biometric detector 130 associated with a user. The biometric detector 130 comprises a millimetre (mm) wave emitter 132 and receiver 134.

In an example, the first property may be one relating to recognition of a face of a user, or a fingerprint of the user or similar property that is distinctive of a user and can be recognised via the use of millimetre wave technology.

The biometric detector 130 may emit millimetre waves in a direction towards the user. At least a portion of the millimetre waves are reflected by the user and detected at the millimetre receiver 134 of the biometric detector 130. The signal received by the receiver 134 may be processed at the biometric detector 130 and a signal sent to the control circuitry 120 or the signal can be sent to the control circuitry 120 unprocessed and the signal may be processed at the control circuitry 120.

Use of millimetre wave technology allows for relatively high definition scanning of for example facial features. Such facial features are indicative of the user and can be used to identify a user as authorised to use the device 100. The device 100 may have a preprogrammed list of users (with associated data) that are allowed to use the device 100. The signal received at the mm receiver 134 may be compared to the list of users to ascertain whether the current potential user is an authorised user for the device 100. If the user is authorised, the control circuitry 120 may update the activation state of the device 100 to an operational state, wherein the device 100 can be used to provide an aerosol to the user.

The full range of operating states of the aerosol provision device 100 may be very wide ranging such that the aerosol provision device 100 can be used with a correspondingly wide range of consumables. In this way, the user need not be limited to only certain types of consumable for use with the aerosol provision device 100. The identification of the user may enable all operating states to be active or may allow a partial range of operating states to be available to the user. This may occur on a user-by-user basis according to access levels to the device 100 for the specific user.

The aerosol provision device 100 may comprise heating arrangements or the like for providing an aerosol from a consumable—the consumable may contain some aerosol generating material or the like. The control circuitry 120 may control the heating arrangement (or the like) according to the signal received from the biometric detector 130. The detector 130 enables the control circuitry 120 to ascertain whether the user is a valid user of the aerosol provision device 100. In an example, the biometric detector 130 may provide a signal to the control circuitry 120, the control circuitry 120 may recognise the signal as belonging to a valid user and enable any operational mode of the device 100. In another example, the biometric detector 130 may provide a signal to the control circuitry 120, the control circuitry 120 may recognise the signal as belonging to an invalid user and prevent any operational mode of the device 100. In this way, protection over the use of the aerosol provision device 100 is provided. This protection is not user intensive; the protection does not rely on the user taking several actions to provide the protection, rather the protection is provided for the user via the biometric detector 130, increasing the user experience of the device 100.

In an example, the biometric detector 130 detects at least one of a face and a fingerprint. In an example, the biometric detector 130 detects both a face and a fingerprint of a user. Each of these options can provide a signal to the control circuitry 120 regarding a property of a potential user of the aerosol provision device 100. Any other suitable element of a user may also or alternatively be detected by the mm technology.

The control circuitry 120 is linked to the biometric detector 130 either wirelessly or wired (as shown in FIG. 1). Prior to operation of the aerosol provision device 100, the biometric detector 130 detect a property of the user and process a signal and/or provide the signal accordingly to the control circuitry 120. The biometric detector 130 may provide more than one signal to the control circuitry 120 to increase the reliability of detection of an authorised user.

The biometric detector 130 may have a recognition window of up to 170 degrees. This can be provided by virtue of the mm emitter 132 that is able to emit and the mm receiver 134 that is able to receive mm signals from a spread of 170 degrees. This enables excellent coverage when in use and therefore the user is less likely to unsuccessfully attempt to be detected. This increases the user experience of the device 100. The recognition window is the window from the emitter that allows for recognition, i.e. the area or window in which the emitter and receiver can operate. As can be appreciated 170 degrees is a vast improvement on most facial recognition technologies that require a user be directly front on to the camera.

The biometric detector 130 may have a recognition range of up to 10 metres. With mm technology, a high power device can provide a recognition range up to 10 metres. This is far greater than most facial recognition technologies presently available. In an energy-saving mode, the recognition range can be reduced to 2 metres, which is still a greater distance than most facial recognition technologies presently available. 10 metres for an aerosol provision device 100 is more than enough recognition range, as this would be enough for a user to be recognised in response to entry to the room in which the aerosol provision device 100 is stored. 2 metres would also be more than sufficient to enable recognition prior to the user being close enough to the device 100 to activate it. In this way, such a range enables the device 100 to provide no barrier to usual use practices of a user. The user need not interact directly with the biometric detector-provided the emitter and receiver are roughly (within 170 degrees) facing towards the user. The user will be recognised before the user can use the device 100, at which point the user experiences no hindrance in use of the device 100. This clearly improves user experience over more arduous or time consuming user authentication processes.

The biometric detector 130 may recognise a user's face or a user's hand. The detector 130 may also recognise individual fingerprints of a user. Utilising a 3D arrangement (with a plurality of emitters and receivers (or one emitter and a plurality of receivers)) the biometric detector 130 may recognise gestures such as hand gestures or the like. An arrangement with a plurality of detectors 130 is able to recognise pre-programmed gestures from the user, such that a user can be identified by a hand movement. The control circuitry 120 of the device 100 can therefore update the activation state of the device 100 in response to recognition of a user's hand gesture (such as a wave) from many metres away.

The biometric detector 130, in an example, is arranged to operate around 60 GHz. This allows the device 100 to provide recognition over a matter of milliseconds or less. In this way, the user experience is further enhanced. By removing delay between the user handling the device 100, the user wishing to activate the device 100, and user verification being completed, this device 100 improves the user experience. This present system provides no impediment to the user's operation of the device 100.

Alternatively, the biometric detector 130, in an example, may be arranged to operate around between 10 to 400 GHz, 10 to 350 GHz, 10 to 300 GHz, 10 to 250 GHz, 10 to 200 GHz, 10 to 150 GHz, 20 to 100 GHz, 30 to 90 GHz, 40 to 80 GHz, 50 to 70 GHz, 55 to 65 GHz or the like. In particular, there can be advantages provided in terms of a less power intensive provision thereby increasing battery life for lower GHz rating against speed of recognition improving user experience for higher GHz.

In an example, the control circuitry 120 is arranged to update an activation state of the aerosol provision device 100 to an operating state in response to receiving a signal from the biometric detector 130 associated with an authorised user. In an example, the control circuitry 120 is arranged to update an activation state of the aerosol provision device 100 to a non-operating state in response to receiving a signal from the detector 130 associated with a non-authorised user.

In a specific example, the device 100 has at least four mm wave emitters and at least three mm wave receivers. This allows for highly accurate 3D measurements, including gesture recognition, and does not require significant energy provision to enable such emitters and receivers to be active. As such, this provides increased accuracy and utility without increasing drain on a power source of the device 100.

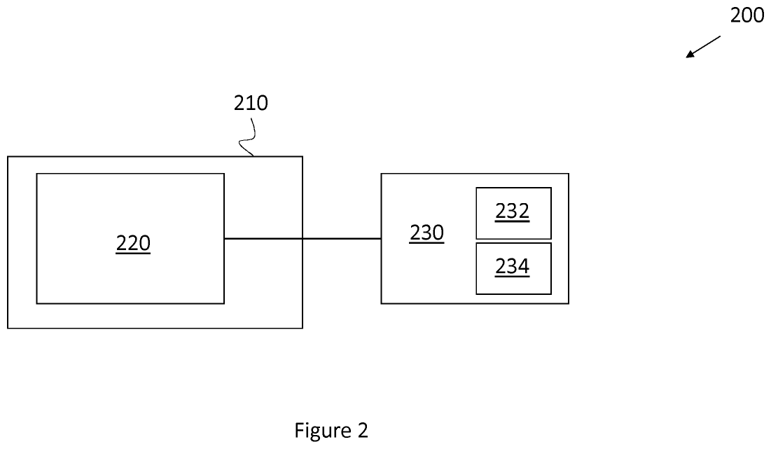

Referring now to FIG. 2, there is a shown a similar system 200 to the device 100 of FIG. 1. Similar features, to those features used in FIG. 1, are shown with the reference numerals increased by 100. For example, the device 100 of FIG. 1 is similar to the system 200 of FIG. 2. Similar or identical features may not be discussed for conciseness.

The system 200 of FIG. 2 has an aerosol provision device 210 comprising control circuitry 220. The system 200 also has a biometric detector 230. The biometric detector 230 is arranged to detect a first property associated with a user of the aerosol provision device 210 and provide a signal to the control circuitry 220. The biometric detector 230 has a mm wave emitter 232 and a mm wave receiver 234. The biometric detector 230 may be linked to the control circuitry 220 either wirelessly (as shown in FIG. 2) or wired via a USB connection or the like.

The system 200 has a biometric detector 230 separate from the aerosol provision device 210. This enables the manufacturing of the aerosol provision device 210 to be simpler and therefore cheaper. The biometric detector 230 may be carried by a user alongside the aerosol provision device 210 and, prior to use of the aerosol provision device 210, the user may activate the biometric detector 230, satisfy user authorisation, and then use the aerosol provision device 210. The aerosol provision device 210 may be in a default operating state of non-operation, i.e. the device 210 cannot be used without first satisfying user authentication by the biometric detector 230. This prioritises safety and ensures that unauthorised users are unable to activate the device 210. The biometric detector 230 may be arranged to communicate with the control circuitry 220 over a short distance communication system such as Bluetooth or Infrared or RFID. This ensures that the user near the biometric detector 230 also is near the aerosol provision device 210 and hinders one user accidentally satisfying authorisation with the biometric detector 230 while the aerosol provision device 210 is in the possession of a 2^{nd} unauthorised user.

The biometric detector 230 may be a mobile device or smart device belonging to the user of the aerosol provision device 210. This arrangement utilises the operability of a separate component thereby reducing the manufacturing requirements on the aerosol provision device 210. This also utilises a component that is likely already possessed by the user. The smart device may be linked to the aerosol provision device 210 via an app or the like.

The present invention involves changing an activation state of the aerosol provision device. In an “operating state”, elements of the aerosol provision device used to generate an aerosol (such as an atomiser, heater or the like) may be activated. The specific activation of the device may require an additional input which may be inhalation on the device, pressing a button on the device or the like. Alternatively, the device may automatically generate aerosol by a heater in response to receiving a signal associated with an authorised or valid user from the biometric detector. The control circuitry may receive such a signal from the biometric detector and send a signal to the heater arrangement or the like to provide an aerosol from an aerosol generating material that may contained within, or separate to, the aerosol provision device.

The term “operating state” refers to a state in which the device may be used to provide an aerosol. The device can provide a large number of “operating states”. Specific aerosol generating materials or aerosol generating material consumables may provide a suitable aerosol for a user under a suitable heating profile (fast, slow, high temperature, low temperature, etc.) or via a suitable heating mechanism (heater element, atomiser, vibrating plate, etc.). As such specific, operating states may dictate the performance of the system, such as selecting the heating mechanisms used and the heating profile used based on the identified user—one user may be able to store a preferred heating profile to be associated with their biometric data. In this way, in response to identification of user 1, corresponding heating mechanism 1 is offered to provide heating profile 1 on the aerosol generating material. In response to identification of user 2, corresponding heating mechanism 2 may be offered to provide heating profile 2 on the aerosol generating material. In this way, different users are provided a bespoke aerosol, in response to recognition of that user. This improves the ease of use, and the use experience, of a device for a user.

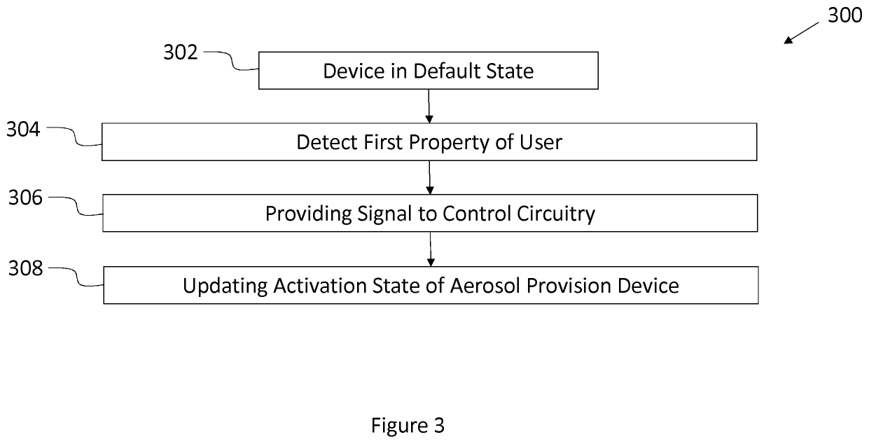

FIG. 3 shows a method 300 of use of an aerosol provision device. In the method 300, the device may start in a default state 302, which may be a non-operating state such that non-valid users cannot use the device. Alternatively, the default operating state may be a restricted operating state where only partial operation of the device is possible.

When a user intends to use the aerosol provision device, the device or system detects a first property of the user 304. The first property is detected using a biometric detector (which may contain a number of individual sensors/detectors as explained above). The detector uses mm wave technology. The signal from the biometric detector is provided to control circuitry of the device 306. In step 408, there is an update of the activation state of the aerosol provision device.

This may take the form of updating the activation state to an operating state such as fully enabled for use, partially enabled for use or prevented from use. As discussed above, this change is based on the detected property from the user. These are used to ascertain a suitability of use for the user. For example, a first authorised user (the owner of the device) may have all functionality unlocked when identified by the biometric detector while a second authorised user (e.g. a friend of the owner borrowing the device) may have only a limited functionality unlocked.

This method provides a user-friendly verification process that provides suitable protection against invalid users while not impeding use for valid users. The method offers a balance between overly strict and overly lenient access protection for the device. The technique may not impact the user at all due to the long range, wide recognition window and extremely fast execution and handling of identification. The method is extremely user friendly.

The method and device disclosed herein enable protection over the use of the device without requiring an arduous authorisation process. This improves the user experience of the device and the safety of general use of the device.

The devices and systems disclosed herein have a biometric detector that obtains data from a user. This data may be processed by a number of components able to compare the data against a database (for example) of authorised users. This data may be analysed on-board the device by e.g. control circuitry. The control circuitry then analyses the signal and evaluates whether to allow or prevent use of the aerosol provision system or aerosol provision device. In another example, the data from the biometric detector may be sent to a remote database or server for analysis. In such an example, the device or system may have a communications module for communicating with the remote database or server. The remote database or server may perform the analysis and provide a signal to the communications module. The signal ultimately sent to the control circuitry by the communication module may be one indicating the control circuitry should or should not allow use of the aerosol provision device or aerosol provision system. This allows for more complex analysis to be performed off the device, which may render the aerosol provision devices more cost efficient to produce.

The term “in response to” is used herein to indicate a second event (such as a signal or change of state of an aerosol provision device) that occurs subsequent to a first event. The second event may occur at a later time, after a predetermined time, or immediately after the first event.

The device and system herein are described as comprising several components that enable several advantages. The components may be disclosed as on-board the device or within the system. The components may be distributed and therefore not necessarily be located on-board the device. The functionality of the device can be provided by communicatively connected components, and such communication may be wireless, enabling such distribution. At which point it is reasonable to foresee that a distributed array of components will operate in the manner of the devices and systems disclosed herein. Components of the device or system may be contained in a further device such as a smartphone, computer, or remote server or the like.

In a particular example, the device disclosed herein may operate with a flavour pod which is replaceable in the device—this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision device, for providing an aerosol for inhalation by a user, comprising: control circuitry for controlling an activation state of the aerosol provision device; a biometric detector arranged to detect a first property associated with a user of the aerosol provision device and provide a signal to the control circuitry, wherein the control circuitry is arranged to update an activation state of the aerosol provision device in response to receiving a signal from the biometric detector associated with a user, wherein the biometric detector comprises a mm wave emitter and receiver.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision device, for providing an aerosol for inhalation by a user, comprising:
control circuitry for controlling an activation state of the aerosol provision device;
a biometric detector arranged to detect a first property associated with a user of the aerosol provision device and provide a signal to the control circuitry,
wherein the control circuitry is arranged to update an activation state of the aerosol provision device in response to receiving a signal from the biometric detector associated with a user,
wherein the biometric detector comprises a mm wave emitter and receiver.

2. An aerosol provision device according to claim 1, wherein the biometric detector has a recognition window of up to 170 degrees.

3. An aerosol provision device according to claim 1, wherein the biometric detector has a recognition range of up to 10 metres.

4. An aerosol provision device according to claim 1, wherein the first property is associated with at least one of a user's face and a user's hand.

5. An aerosol provision device according to claim 1, wherein the biometric detector is arranged to operate at around 10 to 400 GHz.

6. An aerosol provision device according to claim 1, wherein the control circuitry is arranged to update an activation state of the aerosol provision device to an operating state in response to receiving a signal from the biometric detector associated with an authorised user.

7. An aerosol provision device according to claim 1, wherein the control circuitry is arranged to update an activation state of the aerosol provision device to a non-operating state in response to receiving a signal from the detector associated with a non-authorised user.

8. An aerosol provision device according to claim 1, wherein the biometric detector comprises at least four mm wave emitters and at least three mm wave receivers.

9. An aerosol provision system for providing an aerosol for inhalation by a user comprising:
an aerosol provision device comprising control circuitry for controlling an activation state of the aerosol provision device; and,
a biometric detector arranged to detect a first property associated with a user of the aerosol provision device and provide a signal to the control circuitry,
wherein the control circuitry is arranged to update an activation state of the aerosol provision device in response to receiving a signal from the biometric detector associated with a user,
wherein the biometric detector comprises a mm wave emitter and receiver.

10. An aerosol provision system according to claim 9, wherein the biometric detector has a recognition window of up to 170 degrees.

11. An aerosol provision system according to claim 9, wherein the biometric detector has a recognition range of up to 10 metres.

12. An aerosol provision system according to claim 9, wherein the first property is associated with at least one of a user's face and a user's hand.

13. An aerosol provision system according to claim 9, wherein the biometric detector is arranged to operate at around 10 to 400 GHz.

14. An aerosol provision system according to claim 9, wherein the control circuitry is arranged to update an activation state of the aerosol provision device to an operating state in response to receiving a signal from the biometric detector associated with an authorised user.

15. An aerosol provision system according to claim 9, wherein the control circuitry is arranged to update an activation state of the aerosol provision device to a non-operating state in response to receiving a signal from the detector associated with a non-authorised user.

16. An aerosol provision system according to claim 9, wherein the biometric detector comprises at least four mm wave emitters and at least three mm wave receivers.

17. An aerosol provision system according to claim 9, wherein the biometric detector is not integral with the aerosol provision device.

18. An aerosol provision system according to claim 9, wherein the biometric detector is a mobile device.

19. A method of providing an aerosol for inhalation by a user, the method comprising:
detecting, by a biometric detector, a first property associated with a user of an aerosol provision device, the detecting comprising emitting and receiving mm wave signals;
providing, by the biometric detector, a signal to control circuitry of the aerosol provision device;
in response to receiving a signal from the biometric detector, updating, by the control circuitry, an activation state the aerosol provision device.

20. (canceled)
